(19) United States
(12) Patent Application Publication
(10) Pub. No.: US 2006/0072800 A1
(43) Pub. Date: Apr. 6, 2006

(54) Method and system for distributed iterative image reconstruction

(75) Inventors: Bruno Kristiaan Bernard Deman, Clifton Park, NY (US); Samit Kumar Basu, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/950,780

(22) Filed: Sep. 24, 2004

(51) Int. Cl. G06K 9/00

(52) U.S. Cl. 382/131

(57) ABSTRACT

A method for performing distributed statistical iterative reconstruction of an image volume using a computed tomography (CT) system is provided. The method comprises partitioning the image volume across one or more computing nodes. Each computing node receives a portion of measured sinogram data corresponding to a portion of the image volume. The method further comprises distributing a reconstruction operation of the image volume across the one or more computing nodes.

### BACKGROUND OF THE INVENTION

The present invention relates generally to the field of imaging systems. In particular, the invention relates to a method and system for distributed iterative reconstruction of image data acquired from a computed tomography imaging system.

Computed Tomography (CT) scanners operate by projecting fan shaped or cone shaped X-ray beams through an object. The X-ray beams are generated by an X-ray source, and are generally collimated prior to passing through the object being scanned. The attenuated beams are then detected by a set of detector elements. Each detector element produces a signal based on the intensity of the attenuated X-ray beams, and these signals are processed to produce projection data, also called sinogram data. By using reconstruction techniques, such as filtered backprojection, useful images are formed from the projection data.

A computer is able to process and reconstruct images of the portions of the object responsible for the radiation attenuation. As will be appreciated by those skilled in the art, these images are computed by processing a series of angularly displaced projection data. These data are then reconstructed to produce reconstructed images, which are typically displayed on a cathode ray tube, and may be printed or reproduced on film.

Direct reconstruction techniques, such as the filtered backprojection technique are generally fast and computationally efficient, since they allow reconstruction of a three-dimensional image data set in a single reconstruction step. Unfortunately, most direct reconstruction techniques exhibit relatively poor image quality with a low contrast and a significant artifact level.

Iterative reconstruction techniques improve image quality through an iterative step. Iterative reconstruction techniques perform an initial reconstruction followed by iterative updates of the three-dimensional image data set until some threshold criteria are met. Because iterative reconstruction techniques generally allow for the inclusion of detailed system and noise models (as opposed to direct reconstruction techniques, which do not), iterative reconstruction techniques have increased geometrical flexibility and are capable of modeling the physics of the acquisition, thereby reducing artifacts.

Generally, iterative reconstruction techniques require large amounts of computation and are not useful in practice unless the volume to be reconstructed is small. In addition, iterative reconstruction techniques are much slower than direct reconstruction techniques requiring 10-100 times the computational cost as compared to direct reconstruction techniques.

One approach to reduce the total computational cost/time is to distribute the required computational effort over a number of computing entities, such as, for example, general-purpose computers, multiple CPUs on a shared bus or backplane, or one or more pipelines on Field Programmable Gate Arrays (FPGAs). However, in the case of an operation such as image reconstruction, comprising one or more sub-operations that are in general not separable, simply splitting the reconstruction operation into equal parts corresponding to the number of nodes may result in increased overhead due to the need to repeatedly send data back and forth between compute nodes during the sub-operations.

Therefore, there is a need for an efficient technique for distributing an iterative reconstruction operation over one or more computing entities. In addition, there is a need for a distributed iterative technique that minimizes the communications bandwidth requirements between the computing entities, the total computational time and the total effective computational cost.

### BRIEF DESCRIPTION OF THE INVENTION

Embodiments of the present technique address this and other needs. In one embodiment, a method for performing distributed statistical iterative reconstruction of an image volume using a computed tomography (CT) system is provided. The method comprises partitioning the image volume across one or more computing nodes. Each computing node receives a portion of measured sinogram data corresponding to a portion of the image volume. The method further comprises distributing a reconstruction operation of the image volume across the one or more computing nodes.

In a second embodiment, a computed tomography system for performing distributed statistical iterative reconstruction of an image volume is provided. The system comprises an X-ray source configured to project a plurality of X-ray beams through an object and a detector configured to produce a plurality of electrical signals in response to received X-ray beams from the source. The system further comprises a system controller configured to process the plurality of electrical signals to generate measured sinogram data. The system controller is further configured to partition the image volume across one or more computing nodes. Each computing node receives a portion of the measured sinogram data corresponding to a portion of the image volume. Then, the system controller is configured to distribute a reconstruction operation of the image volume across the one or more computing nodes.

### BRIEF DESCRIPTION OF THE DRAWINGS

FIG. 1 is a diagrammatical representation of an exemplary CT system in accordance with aspects of the present technique;

FIG. 2 is a diagrammatical representation of an exemplary distributed source for use with a system of the type illustrated in FIG. 1;

FIG. 3 is a diagrammatical representation of a portion of detector for use with the system illustrated in FIG. 1;

FIG. 4 is an illustration of a typical data acquisition configuration using circular cone beam geometry;

FIG. 5 is an illustration of distributed iterative reconstruction of an image volume using the CT system of FIG. 1, in accordance with one embodiment of the present technique; and

FIG. 6 is an illustration of distributed iterative reconstruction of an image volume using the CT system of FIG. 1, in accordance with a second embodiment of the present technique.

### DETAILED DESCRIPTION OF SPECIFIC EMBODIMENTS

Disclosed herein, is a method and system for efficiently distributing an iterative reconstruction operation over one or more computing entities. The present distributed iterative reconstruction technique, as will be described in greater detail below, minimizes the communication bandwidth requirements between the computing entities, the total computational time and the total effective computational cost of the iterative reconstruction.

Iterative reconstruction techniques, in general, start with an initial image estimate. This initial image estimate is updated and transformed back and forth between the projection domain and the image domain. The particular manner in which transformation between the domains is performed distinguishes different reconstruction techniques. For instance, iterative Filtered Backprojection (FBP) methods use FBP to reconstruct an image and they use a Radon or Fan Beam (or other, depending on the geometry) transform to generate the calculated sinogram.

More specifically, in an iterative reconstruction technique, a calculated sinogram (i.e., a set of projection data predicted from the current estimate of the image or volume) is compared with the actual measured sinogram data. Initially, the calculated sinogram is a transformation from an estimated reconstructed image. In the first iteration, the reconstructed image may be any appropriate default setting. As a result of the comparison of the calculated sinogram and the measured sinogram, a sinogram error is produced. The sinogram error is then transformed back to the image domain to produce a correction image. Thus, in a subsequent iteration, the correction image is used along with the previous reconstructed image to create an updated reconstructed image for the next iteration. Thereafter, the process is repeated for a desired number of iterations or until some optimization stopping criterion is met.

In general, iterative reconstruction techniques may be classified into two broad categories namely, statistical iterative reconstruction techniques and non-statistical iterative reconstruction techniques. Non-statistical iterative reconstruction techniques generally include the algebraic reconstruction technique (ART), the iterative filtered backprojection (IFBP) technique, the least squares reconstruction technique, the weighted least squares reconstruction technique and the iterative coordinate descent technique. Statistical iterative reconstruction techniques include the maximum likelihood reconstruction technique, the maximum a posteriori reconstruction technique, the least squares reconstruction technique, the weighted least squares reconstruction technique and the iterative coordinate descent technique. In one embodiment of the invention, the present technique is based on a statistical iterative reconstruction technique. As is known by those skilled in the art, statistical iterative reconstruction techniques substantially reduce image noise or, for the same image noise, require less X-ray dose to a patient. It is, however, to be appreciated that the present technique may be applied, in general, to any iterative reconstruction technique known in the art.

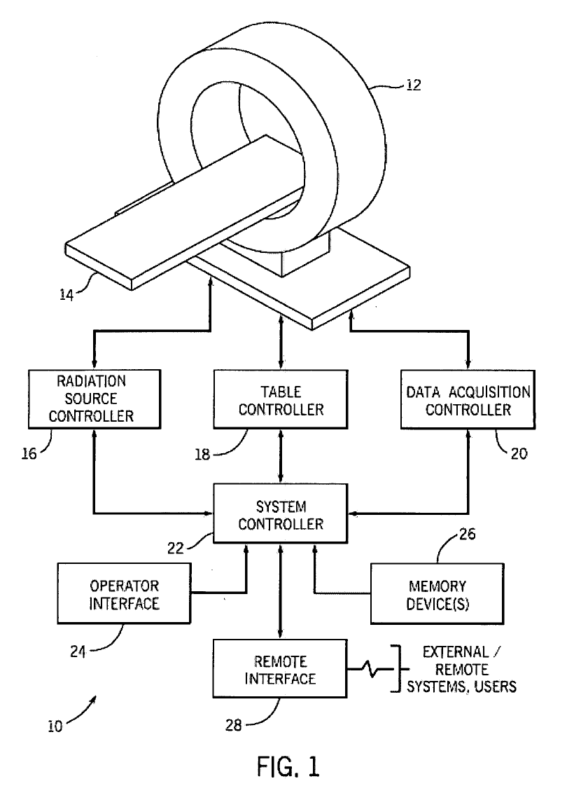

Referring initially to FIG. 1, a computed tomography (CT) system is illustrated and designated generally by reference numeral 10. In the illustrated embodiment, the computed tomography (CT) system 10 is designed to perform distributed iterative reconstruction of an image volume in accordance with embodiments of the present technique, as will be described in greater detail below. The CT system 10 comprises a scanner 12 formed of a support structure and internally containing one or more stationary or rotational sources of X-ray radiation (not shown in FIG. 1) and one or more stationary or rotational digital detectors (not shown in FIG. 1). The scanner is configured to receive a table 14 or other support for a patient, or, more generally, a subject to be scanned. The table can be moved through an aperture in the scanner to appropriately position the subject in an imaging volume or scanning plane during imaging sequences.

The system further includes a radiation source controller 16, a table controller 18 and a data acquisition controller 20, which may all function under the direction of a system controller 22. The radiation source controller 16 regulates timing for discharges of X-ray radiation which is directed from points around the scanner 12 toward a detector element on an opposite side thereof, as discussed below. In the case of stationary CT arrangements, the radiation source controller 16 may trigger one or more emitters in a distributed X-ray source at each instant in time for measuring multiple projection data. In certain arrangements, for example, the X-ray radiation source controller 16 may trigger emission of radiation in sequences so as to collect adjacent or non-adjacent measurements of projection data around the scanner. Many such projection data may be collected in an examination sequence, and data acquisition controller 20, coupled to detector elements as described below, receives electrical signals from the detector elements and processes the signals for storage and image reconstruction. In configurations described below in which one or more sources are rotational, source controller 16 may also direct rotation of a gantry on which the source or sources are mounted. Table controller 18, then, serves to appropriately position the table and subject thereon in a plane in which the radiation is emitted, or generally within a volume to be imaged. The table may be displaced between imaging sequences or during certain imaging sequences, depending upon the imaging protocol employed. Moreover, in configurations described below in which one or more detectors or detector segments are rotational, data acquisition controller 20 may also direct rotation of a gantry on which the detector or detectors are mounted.

System controller 22 generally regulates the operation of the radiation source controller 16, the table controller 18 and the data acquisition controller 20. The system controller 22 may thus cause radiation source controller 16 to trigger emission of X-ray radiation, as well as to coordinate such emissions during imaging sequences defined by the system controller. The system controller may also regulate movement of the table in coordination with such emission so as to collect projection data corresponding to image volumes of particular interest, or in various modes of imaging, such as helical acquisition modes. Moreover, system controller 22 coordinates rotation of a gantry on which, either the source(s), detector(s), or both are mounted in the case of rotating CT geometries or arrangements. The system controller 22 also receives data acquired by data acquisition controller 20 and coordinates storage and processing of the data.

It should be borne in mind that the controllers, and indeed various circuitry described herein, may be defined by hardware circuitry, firmware or software. The particular protocols for imaging sequences, for example, will generally be defined by code executed by the system controllers. Moreover, initial processing, conditioning, filtering, and other operations required on the projection data (or sinogram data) acquired by the scanner may be performed in one or more of the components depicted in FIG. 1. For example, as described below, detector elements will produce analog signals representative of depletion of a charge in photodiodes positioned at locations corresponding to elements of the detector used for data acquisition. Such analog signals are converted to digital signals by electronics within the scanner, and are transmitted to the data acquisition controller 20. Partial processing may occur at this point, and the signals ultimately transmitted to the system controller for further filtering and processing. In the same manner, image reconstruction may be accomplished by application specific integrated circuits residing in the system controller 20, by algorithms executed on the system controller 22, or by remote systems that can access the same data stored in memory device 26. In accordance with the present technique, the system controller is configured to partition the image volume across one or more computing nodes. Each computing node receives a portion of the measured sinogram/projection data corresponding to a portion of the image volume. Then, the system controller is configured to distribute the operation of reconstructing the image volume across the computing nodes, as will be described in greater detail below.

System controller 22 is also coupled to an operator interface 24 and to one or more memory devices 26. The operator interface may be integral with the system controller, and will generally include an operator workstation for initiating imaging sequences, controlling such sequences, and manipulating projection data acquired during imaging sequences. The memory devices 26 may be local to the imaging system, or may be partially or completely remote from the system. Thus, imaging devices 26 may include local, magnetic or optical memory, or local or remote repositories for projection data for reconstruction. Moreover, the memory devices may be configured to receive raw, partially processed or fully processed projection data measurements for reconstruction.

System controller 22 or operator interface 24, or any remote systems and workstations, may include software for image processing and reconstruction. Therefore, some or all of the image processing may be performed remotely by additional computing resources based upon raw or partially processed image data. As will be appreciated by those skilled in the art, such processing of CT projection data may be performed by a number of mathematical algorithms and techniques. In accordance with the present technique, iterative reconstruction techniques are used to process and reconstruct the image data acquired by the imaging system. A remote interface 28 may be included in the system for transmitting data from the imaging system to such remote processing stations or memory devices.

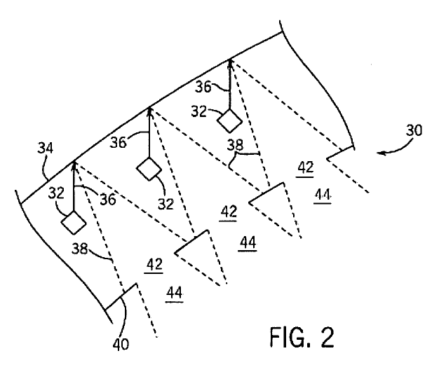

FIG. 2 illustrates a portion of an exemplary distributed X-ray source of the type that may be employed in the CT system 10 of FIG. 1. As shown in FIG. 2, in an exemplary implementation, the distributed X-ray source 30 may include a series of electron beam emitters 32 that are coupled to radiation source controller 16 shown in FIG. 1, and are triggered by the source controller during operation of the scanner. The electron beam emitters 32 are positioned adjacent to a distributed target 34. Upon triggering by the source controller, the electron beam emitters 32 may emit electron beams 36 toward target 34. The target 34, which may, for example, be a tungsten rail or element, emits X-ray radiation, as indicated at reference numeral 38, upon impact of the electron beams. In reflection mode, X-rays are meant to be produced primarily on the same side of the target as where the electrons impact. In transmission mode, X-rays are produced at the opposite side of the target. The X-ray beams 38 are directed, then toward a collimator 40, which is generally opaque to the X-ray radiation, but which includes openings or apertures 42. The apertures 42 may be fixed in dimension, or may be adjustable. Apertures 42 permit a portion of the X-ray beams to penetrate through the collimator to form collimated beams 44 that will be directed to the imaging volume of the scanner, through the subject of interest, and that will impact detector elements on an opposite side of the scanner.

A number of alternative configurations for emitters or distributed sources may, of course, be envisaged. Moreover, the individual X-ray sources in the distributed source may emit various types and shapes of X-ray beams. These may include, for example, fan-shaped beams, cone-shaped beams, and beams of various cross-sectional geometries. Similarly, the various components comprising the distributed X-ray source may also vary. The emission devices may be one of many available electron emission devices, for example, thermionic emitters, carbon-based emitters, photo emitters, ferroelectric emitters, laser diodes, monolithic semiconductors, etc. Although a distributed source configuration is specifically mentioned here, any combination of one or more rotating-anode, stationary-anode, or distributed X-ray sources may be utilized in the CT system 10.

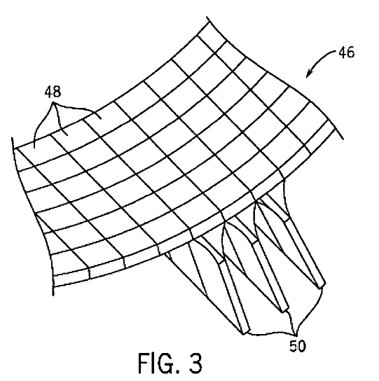

FIG. 3 illustrates a portion of a detector that may be employed by the CT system 10 of FIG. 1. The detector arrangement may be generally similar to detectors used in conventional rotational CT systems, but can also be extended around a greater portion or the entire inner surface of the scanner in certain embodiments. Each detector may be comprised of detector elements with varying resolution to satisfy a particular imaging application. In general, the detector 46 includes a series of detector elements 48 and associated signal processing circuitry 50. These detector elements may be of one, two or more sizes, resulting in different spatial resolution characteristics in different portions of the measured projection data. Each detector element may include an array of photodiodes and associated thin film transistors. X-ray radiation impacting the detectors is converted to lower energy photons by a scintillator and these photons impact the photodiodes. A charge maintained across the photodiodes is thus depleted, and the transistors may be controlled to recharge the photodiodes and thus measure the depletion of the charge. By sequentially measuring the charge depletion in the various photodiodes, each of which corresponds to a pixel in the collected data for each acquisition, data is collected that indirectly encodes radiation attenuation at each of the detector pixel locations. This data is processed by the signal processing circuitry 50, which will generally convert the analog depletion signals to digital values, perform any necessary filtering, and transmit the acquired data to the system controller 22 of the imaging system 10 in FIG. 1 as described above. Although a detector configuration comprised of scintillation material and storage diodes is mentioned, any suitable detector for measuring X-rays may be used with the present technique.

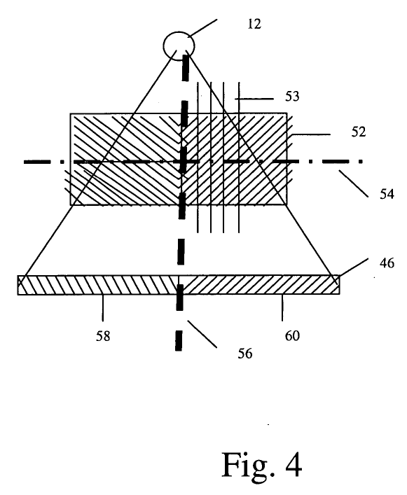

FIG. 4 is an illustration of a typical data acquisition configuration using circular cone beam geometry. In accordance with the present technique, data acquisition using cone beam geometry is described as an exemplary embodiment. However, it is to be appreciated that other geometries such as two-dimensional fan beam or parallel beam geometries may also be used. As shown in FIG. 4, a volume to be imaged, indicated by the reference numeral 52, is positioned within a field of view between a cone beam X-ray point source 12 and the detector 46. The image volume 52 generally corresponds to a patient or an object that is being imaged. An axis of rotation 54 passes through the field of view and the image volume 52. For scanning the image volume 52 at a plurality of angular positions, the source 12 moves relative to the image volume 52 and the field of view along a circular scanning trajectory, while the detector 46 remains fixed with respect to the source 12. As a result of the relative movement of the cone beam source 12 to different angular positions, along a scan path, the detector 46 acquires corresponding sets of cone beam projection data to reconstruct the image volume 52. Each set of cone beam data is representative of X-ray attenuation caused by the image volume at different angular positions of the source 12. In accordance with the present technique, the reconstruction of the image volume is split into two independent processes in the longitudinal direction or the Z-plane, both in the detector 46 and in the image volume 52. Referring to FIG. 4, the detector 46 is divided into two parts, 58 and 60 that are delimited by the mid plane 56. As used herein, the “mid plane” refers to the plane, in which the source 12 rotates. The image volume 52 may be further divided into a number of partitions (or slabs in the Z-plane), indicated by the reference numeral 53, for example. In general, a slab may contain a single image slice (that is, one plane of voxels) or may contain multiple image slices (that is, multiple planes of voxels)

As will be described in greater detail below, each slab, such as, for example, 53 in the image volume 52 is assigned to an independent computing node. As will be appreciated by those skilled in the art, the primary advantages of cone-beam geometry include reduced data acquisition time, improved image registration, the ability to perform cine or fluoro applications (since, in general, a large portion of the patient is in the X-ray beam at all times), improved image resolution, and optimized photon utilization.

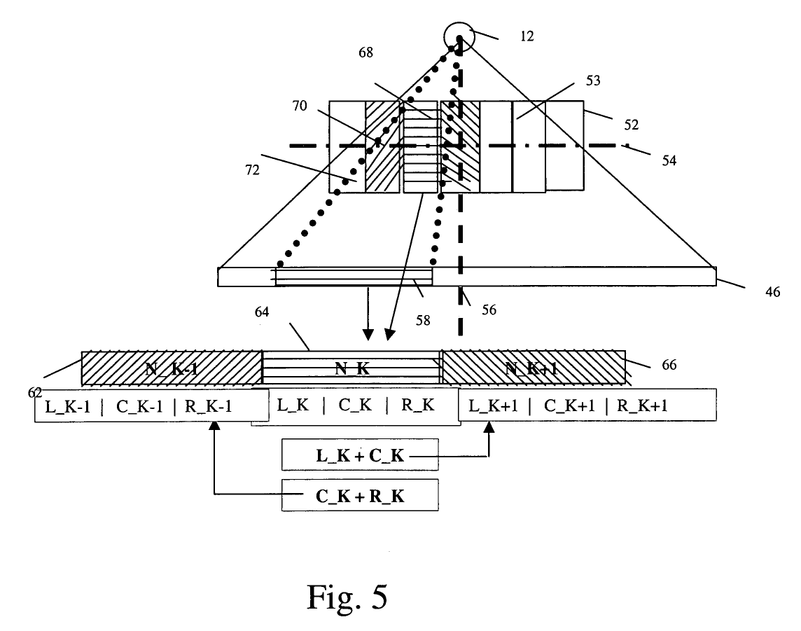

FIG. 5 is an illustration of distributed iterative reconstruction of an image volume using the CT system 10 in accordance with one embodiment of the present technique. Referring to FIG. 5, the image volume 52 is divided into a number of slabs or partitions, such as 53 and 68 for example. Each slab is assigned to a computing node, such as for example, node N_K−1, 62, node N_K, 64 or node N_K+1, 66. For example, as shown in FIG. 5, slab 68 is assigned to node N_K, 64. The computing nodes may comprise computers, Field Programmable Gate Array (FPGA) units, ASIC units or multiple CPUs. In accordance with the present technique, each node is treated as a computational entity, and the computing nodes are connected through a communication system so that data can be exchanged between the nodes. Further, it should be noted that, the exemplary partitions of the image volume 52 depicted in FIG. 5 is for illustrative purposes only. The image volume may be partitioned into additional or fewer computing nodes that what is indicated in FIG. 5.

Referring again to FIG. 5, each computing node receives cone beam projection data (or alternatively, measured sinogram data) corresponding to its portion of the image volume 52. In particular, as shown in FIG. 5, the portion of measured sinogram data in each computing node is limited to a detector part, such as indicated by the reference numeral, 58, onto which the corresponding image volume partition is projected. Accordingly, each computing node reconstructs a portion of the image volume that corresponds to a fraction/subset of the projection data associated with that computing node. Further, in accordance with the present embodiment, each computing node, such as for example 62, 64 or 66, receives, computes and stores a calculated sinogram corresponding to its portion of the image volume. It should be noted that since, a detector part such as 58, is generally, also impacted by projection data associated with one or more neighboring image volumes such as 70 and 72, each computing node computes and stores a corresponding contribution to the calculated sinogram of one or more neighbors adjacent to the computing node.

Referring again to FIG. 5, for the computing node N_K, 64, its adjacent neighbors are N_K−1, 62 and N_K+1, 66. The computing node N_K, 64, stores its own contribution of the portion of the calculated sinogram in C_K, stores the corresponding contributions of all its right neighbors in R_K, and stores the corresponding contributions of all its left neighbors in L_K. That is, in accordance with the present technique, each computing node makes a distinction between its own contribution to the calculated sinogram and the contribution to the calculated sinogram from its left and right neighbors.

Further, in accordance with the present embodiment, each computing node communicates the corresponding contributions of the calculated sinogram to its adjacent neighbors as follows. Referring to FIG. 5, node N_K calculates the sum of the calculated sinogram stored in C_K and the corresponding contribution of the calculated sinogram of its left neighbors, stored in L_K, (denoted by the expression, C_K+L_K), and sends this to N_K+1, which uses this as an updated version of its own L_K+1. Similarly, N₁₃ K+1 computes the expression (C_K+1+R_K+1) and sends this back to N—K, which uses this as an updated version of its own R_K. Therefore, each computing node shares information, in this case, updated calculated sinograms, with its adjacent neighbors. This scheme is particularly well suited to topologies in which each node is connected serially to other nodes, in a linear or ring topology, for example. Furthermore, each node, such as for example, N_K continuously computes updates for its own contribution C_K to its portion of the sinogram, generates a total calculated sinogram by adding C_K, L_K, and R_K subtracts the total calculated sinogram from the measured sinogram, updates its portion of the reconstructed image volume, recalculates C_K, and so forth. In this manner, each computing node computes an updated calculated sinogram based on the contribution received from its neighbors.

From the updated calculated sinogram, each computing node reconstructs a portion of the image volume using any iterative reconstruction technique, known in the art. In a particular embodiment of the present technique, the iterative reconstruction is performed using statistical iterative reconstruction techniques such as the maximum likelihood reconstruction technique, the maximum a posteriori reconstruction technique, the least squares reconstruction technique, the weighted least squares reconstruction technique or the iterative coordinate descent technique. In addition, in accordance with the present technique, corresponding contributions of calculated sinograms are communicated to the neighbors adjacent to each computing node and an updated calculated sinogram is computed after every pre-determined number of iterations. This reuse of the contributed sinograms further minimizes the communication bandwidth requirement between the computing nodes and the total effective arithmetic cost. For example, referring to FIG. 5, if node N_K currently has certain values for L_K and R_K, it can perform a number of iterations using these values before updating them, and before sending updates to its neighbors. Therefore, in every iteration, node N_K updates C_K and its portion of the reconstructed image, but L_K and R_K do not have to be refreshed every single iteration. After a number of iterations node N_K gets updated values for R_K and L_K from its neighbors and sends updated values for R_K−1 and L_K+1 to its left and right neighbor respectively.

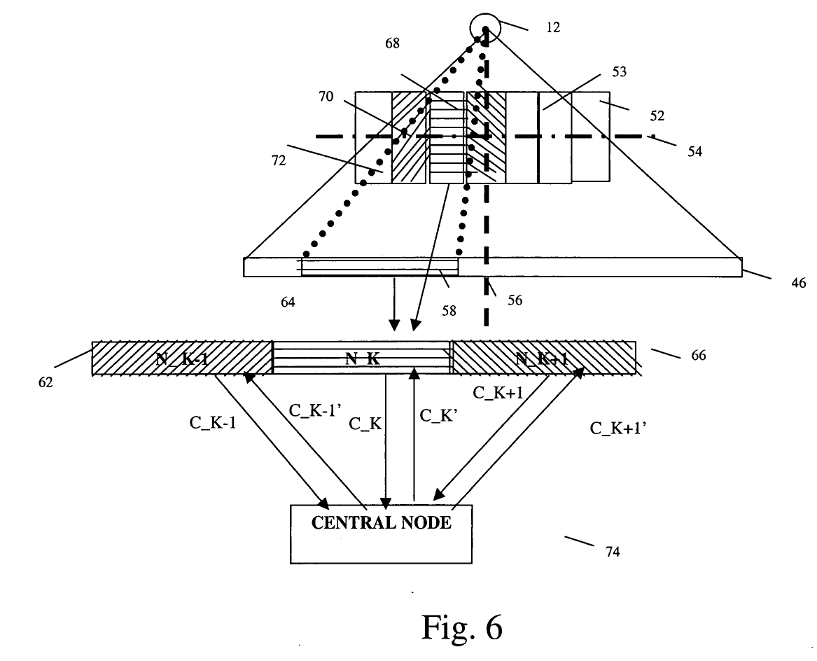

FIG. 6 is an illustration of distributed iterative reconstruction of an image volume using the CT system 10 in accordance with a second embodiment of the present technique. In accordance with this embodiment, the computing nodes, N_K−1, 62, N_K, 64 and N_K+1, 66, communicate contributions to its neighbors via a central computing node, 74 as shown in FIG. 6. It should be noted that, the exemplary partitions of the image volume 52 depicted in FIG. 6 is for illustrative purposes only. The image volume may be partitioned into additional or fewer computing nodes that what is indicated in FIG. 6.

Referring to FIG. 6, the central computing node accumulates the portion of the calculated sinogram data from each computing node and sends back a resulting updated calculated sinogram to each computing node. As shown in FIG. 6, in an exemplary embodiment, the central computing node 74, with reference to node N_K, 64, for example, receives a portion of the calculated sinogram C_K, corresponding to node N_K, and also receives corresponding contributions of the calculated sinogram, C_K+1, C_K+2 (not shown in figure) and C_K−1, C_K−2 (not shown in figure), from all the other nodes, and computes the resulting updated calculated sinogram, C_K′. This updated calculated sinogram is then sent back to node N_K. From the updated calculated sinogram, each computing node reconstructs a portion of the image volume using any iterative reconstruction technique, known in the art. In a particular embodiment of the present technique, the iterative reconstruction is performed using statistical iterative reconstruction techniques such as the maximum likelihood reconstruction technique, the maximum a posteriori reconstruction technique, the least squares reconstruction technique, the weighted least squares reconstruction technique or the iterative coordinate descent technique. This embodiment of the present technique is particularly well suited to star-connected topologies, in which the nodes are connected to a central computing server but not necessarily connected to each other.

The embodiments illustrated and described above provide an efficient technique for distributing an iterative reconstruction operation over one or more computing entities. By using the present technique for distributing the computation effort over multiple computing entities, the present distributed iterative reconstruction technique minimizes the communications bandwidth requirements between one or more computing entities, the total computational time and the total effective computational cost.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for performing distributed statistical iterative reconstruction of an image volume using a computed tomography system comprising:
partitioning the image volume across one or more computing nodes, wherein each computing node receives a portion of measured sinogram data corresponding to its portion of the image volume; and
distributing a reconstruction operation of the image volume across the one or more computing nodes.

2. The method of claim 1, wherein the portion of measured sinogram data in each computing node is limited to a detector part onto which the corresponding image volume partition is projected.

3. The method of claim 1, wherein each computing node computes and stores a calculated sinogram corresponding to its portion of the image volume.

4. The method of claim 3, wherein each computing node further computes and stores a corresponding contribution to the calculated sinogram of one or more neighbors adjacent to the computing node.

5. The method of claim 4, wherein each computing node further communicates the corresponding contributions of the calculated sinogram to the one or more neighbors adjacent to the computing node.

6. The method of claim 5, wherein each computing node further computes an updated calculated sinogram based on the contribution received from the one or more neighbors.

7. The method of claim 6, wherein the communication and the update are performed after a pre-determined number of iterative steps comprising the iterative reconstruction.

8. The method of claim 4, further comprising a central computing node, wherein the one or more computing nodes communicate the corresponding contributions to the one or more neighbors via a central computing node.

9. The method of claim 8, wherein the central computing node accumulates the portion of the calculated sinogram data corresponding to each computing node and sends a resulting updated calculated sinogram to each computing node.

10. The method of claim 1, wherein the computing nodes are selected from the group consisting of computers, FPGA units, ASIC units and multiple CPU units.

11. The method of claim 1, wherein the distributed statistical iterative reconstruction is performed using a maximum likelihood, a maximum a posteriori, a least squares, or a weighted least squares reconstruction technique.

12. The method of claim 1, wherein the distributed statistical iterative reconstruction is performed using an iterative coordinate descent technique.

13. The method of claim 1, wherein the distributed statistical iterative reconstruction of the image volume is implemented for a cone-beam geometry performing an axial scan.

14. The method of claim 1, wherein the image volume is partitioned in a longitudinal direction into a plurality of image slabs.

15. A method for performing distributed iterative reconstruction of an image volume using a computed tomography system comprising:
partitioning the image volume across one or more computing nodes, wherein each computing node receives a portion of measured sinogram data corresponding to its portion of the image volume;
computing and storing a calculated sinogram corresponding to a portion of the image volume in each computing node;
computing and storing a corresponding contribution to the calculated sinogram of one or more neighbors adjacent to each computing node;
communicating the corresponding contribution of the calculated sinogram to the one or more neighbors adjacent to the computing node; and
updating the calculated sinogram based on the contribution received from the one or more neighbors.

16. The method of claim 15, wherein the portion of measured sinogram data in each computing node is limited to a detector part onto which the corresponding image volume partition is projected.

17. The method of claim 15, wherein the communicating and the updating are performed after a pre-determined number of iterative steps comprising the iterative reconstruction.

18. The method of claim 15, further comprising a central computing node, wherein the one or more computing nodes communicate the corresponding contributions to the one or more neighbors via a central computing node.

19. The method of claim 18, wherein the central computing node accumulates the portion of the calculated sinogram data corresponding to each computing node and sends a resulting updated calculated sinogram data to each computing node.

20. The method of claim 15, wherein the computing nodes are selected from the group consisting of computers, FPGA units, ASIC units and multiple CPU units.

21. The method of claim 15, wherein the distributed iterative reconstruction is performed using a maximum likelihood, a maximum a posteriori, a least squares, or a weighted least squares reconstruction technique.

22. The method of claim 15, wherein the distributed iterative reconstruction is performed using an iterative coordinate descent technique.

23. The method of claim 15, wherein the distributed iterative reconstruction of the image volume is implemented for a cone-beam geometry performing an axial scan.

24. The method of claim 15, wherein the image volume is partitioned in a longitudinal direction into a plurality of image slabs.

25. A computed tomography system for performing distributed statistical iterative reconstruction of an image volume comprising:
an X-ray source configured to project a plurality of X-ray beams through an object;
a detector configured to produce a plurality of electrical signals in response to received X-ray beams from the source; and
a system controller configured to process the plurality of electrical signals to generate measured sinogram data, wherein the system controller is further configured to partition the image volume across one or more computing nodes, wherein each computing node receives a portion of the measured sinogram data corresponding to a portion of the image volume; and distribute a reconstruction operation of the image volume across the one or more computing nodes.
